(19) United States
(12) Patent Application Publication
(10) Pub. No.: US 2024/0170772 A1
(43) Pub. Date: May 23, 2024

(54) PROTECTIVE ARRANGEMENT, MOTOR VEHICLE AND METHOD FOR OPERATING A PROTECTIVE ARRANGEMENT FOR PROTECTING A HIGH-VOLTAGE BATTERY OF A MOTOR VEHICLE

(71) Applicant: AUDI AG, Ingolstadt (DE)

(72) Inventors: Tobias ENZINGER, Hohenwart CT Freinhausen (DE); Thomas HOFFMANN, Riedenburg (DE); Markus NIEDERMEIER, Wolnzach (DE)

(73) Assignee: AUDI AG, Ingolstadt (DE)

(21) Appl. No.: 18/515,877

(22) Filed: Nov. 21, 2023

(30) Foreign Application Priority Data
Nov. 22, 2022 (DE) 102022130847.2

(51) Int. Cl. H01M 50/141; H01M 10/625; H01M 10/63; H01M 50/24

(52) U.S. Cl. CPC H01M 50/141; H01M 10/625; H01M 10/63; H01M 50/24; H01M 2200/00; H01M 2220/20

(57) ABSTRACT

A protective arrangement for a motor vehicle for protecting a high-voltage battery of the motor vehicle from the penetration of liquid. The protective arrangement has an electrical component connected to the high-voltage battery via a cable, which component has a drainage device with a drain opening and a closure, by which the drain opening can be released depending on the pressure, a cooling circuit with a circuit component arranged on the component housing, through which component a coolant can flow, and with a pump to pump coolant through the circuit component, and a control device, which is designed to control the pump depending on detection of at least a probable penetration of coolant into the component housing in such a way that an increased pump power is at least temporarily provided by the same if the pump is not yet in a state of maximum pump performance.

### FIELD

The invention relates to a protective arrangement for a motor vehicle for protecting a high-voltage battery of the motor vehicle from the penetration of liquid. Furthermore, the invention also relates to a motor vehicle and a method for operating a protective arrangement.

### BACKGROUND

Basically, a battery housing of a high-voltage battery for a motor vehicle is well sealed and, above all, fluidically sealed from the environment in order to prevent liquid from penetrating into the battery housing. If liquid were to get into the battery housing, this could lead to short circuits in the cells and, in the worst case, a battery fire. However, in rare cases of failure, there is always the possibility that liquid can get into the battery housing, for example in the event of a leak in a coolant system.

DE 10 2013 018 416 A1 describes a battery housing for accommodating a battery consisting of a plurality of battery cells with an outlet opening arranged in the lower region in intended use. The outlet opening is provided with a valve device which can be actively controlled or passively operated autonomously depending on at least one environmental condition and/or a liquid level in the battery housing.

If liquid gets into the battery housing, it can be drained through the outlet opening. However, it would be desirable to ensure that liquid cannot get into such a battery housing even in the event of a fault.

### SUMMARY

The object of the present invention is therefore to provide a protective arrangement, a motor vehicle, and a method by means of which a high-voltage battery of the motor vehicle can be protected as well as possible from liquid, even in the event of a fault.

A protective arrangement according to the invention for a motor vehicle for protecting a high-voltage battery of the motor vehicle from the penetration of liquid has an electrical component which can be connected to the high-voltage battery via a cable and which comprises a component housing and a drainage device connected to the component housing with a drain opening in the component housing, via which, if liquid penetrates into the component housing, the liquid can be drained from the component housing into an region surrounding the component outside the high-voltage battery, wherein the drainage device has a closure which closes the drain opening and by means of which the drain opening can be released depending on the pressure. The protective arrangement further comprises a cooling circuit with a circuit component through which a coolant can flow, and with a first pump for pumping coolant through the circuit component, wherein the circuit component is arranged on the component housing. In addition, the protective arrangement comprises a detection device that is designed to detect an at least presumed penetration of liquid from the circuit component into the component housing according to at least one predetermined detection criterion, and a control device that is designed to control the first pump depending on the detection of the at least presumed penetration by the detection device in such a way that an increased pump power is provided at least temporarily by the same, if the first pump is not yet in a state of maximum pump power.

The invention is based, on the one hand, on the knowledge that liquid can not only penetrate directly into a high-voltage battery or into the battery housing, assuming a fault occurs, for example due to a leak in a coolant hose running within the battery or the like, but that in principle there is also a further path passing through electrical cables that are connected to a high-voltage battery. Such electrical cables are usually constructed in multiple layers and include numerous cavities, for example between the individual, electrically conductive strands and/or between the individual cable layers such as shielding, insulation, outer jacket and so on. Typically, numerous high-voltage components within a motor vehicle are directly or indirectly coupled or electrically connected to the high-voltage battery via such high-voltage lines, which also typically have a relatively large cross section. If liquid gets into a component of the motor vehicle that is different from the high-voltage battery itself due to a fault, such as a leak, for example due to a leak in a cooling device connected to this component, this liquid in this component can not only lead to damage to this component itself and system failure, but could also reach other components via the cables and, although very unlikely due to the chain of numerous very rare error events, in the worst case even reach the high-voltage battery. Such a situation can be prevented by various sealing measures. Additional protection, which also makes it possible, for example, to simplify such sealing measures, can now be provided by the invention taking advantage of this knowledge, in that those components of the motor vehicle that are electrically connected or can be connected to the high-voltage battery are provided with a corresponding protective device, namely with a drainage device, via which the liquid can be drained away in the event of liquid penetration into the component housing of this component, in particular in such a way that it cannot or at least cannot get into the cable that leads directly or indirectly to the high-voltage battery, at least not in significant quantity. Above all, the invention is based on the knowledge that it is in principle possible to provide the water-transmitting interfaces to a high-voltage battery, for example the at least one electrical component and in particular the connection region for the cable, with sealing measures, but that to carry out the sealing measures in such a way that they remain completely sealed for a long time in the event of a fault is significantly more complex than carrying out the sealing measures in such a way that they only have to stay reasonably tight for a short time, namely so tight that enough pressure briefly builds up in the components to allow a drainage, i.e. the closure opens and thus releases the drain opening. On the one hand, the drainage device makes it advantageously possible to prevent liquid from damaging the high-voltage battery in a very simple manner. By providing the drainage device, the excess pressure due to the penetrating liquid in the relevant component can also be limited in the event of a fault, so that a flashover onto other components can be excluded or at least greatly reduced. In other words, the draining of the liquid leads to a pressure reduction, which can prevent the liquid from being pumped and pressed via the cable into the high-voltage battery.

Above all, the invention is based on the knowledge that it is possible to cause or support an opening of the closure of the drain opening by temporarily increasing the pumping power of the first pump, which is provided for pumping the coolant through the circuit component. If coolant from the circuit component penetrates into the component housing due to a leak, the pressure in the component housing can ultimately also be correspondingly increased, at least temporarily, by increasing the coolant pressure, which is pumped through the circuit component by means of the first pump. This means that the drain opening, which can be released depending on the pressure, can be opened even earlier. This also has the advantage that the drain opening, which can be released passively and depending on pressure, can be closed much more robustly in the normal state. In other words, for example, the pressure threshold value at which the drain opening is released by opening the closure can be chosen to be significantly higher, since such a pressure threshold value can be achieved significantly faster and more reliably by the first pump specifically pumping the coolant with a higher pumping power through the cooling circuit or at least through the circuit component and thus into the component housing. As soon as the closure is opened, no further pressure build-up in the electrical component is possible and the risk of further longitudinal water transfer via the high-voltage lines is averted. Further coolant flowing through the leak then escapes into the environment. This also makes a clear diagnosis possible. The fact that the electrical component is further destroyed by this measure is also irrelevant, since the component is already defective due to the leakage due to the penetration of liquid.

A component that can be connected to the high-voltage battery via a cable, in particular electrically, is to be understood as meaning a component which, in its intended arrangement in the motor vehicle and when connected as intended, is connected electrically indirectly or directly to the high-voltage battery via the at least one cable. The component is preferably a component which is part of a high-voltage electrical system of the motor vehicle. In particular, the component can represent a high-voltage component, in particular an electrical high-voltage component. A connection for a charging cable, which is located in a charging socket of the motor vehicle, should also be considered as meaning such a high-voltage component. High-voltage components, in particular, are connected to each other or to the high-voltage battery directly or indirectly, for example via a connection box, a so-called battery junction box, using relatively thick high-voltage cables. These typically have a relatively large cable cross-section, in particular in the range of several square millimeters, for example with a cross-section of at least four square millimeters, in particular at least five or at least six square millimeters, particularly preferably at least seven or at least eight square millimeters, and so on. Especially with cables with such a large cross-section, the risk of undesirable liquid transfer in the event of liquid accumulation in the affected component is worth considering. It is therefore very advantageous to provide a drainage device in such a component. In particular, several components of the high-voltage electrical system can be designed with such a drainage device as part of the protective arrangement. This can further increase security.

A region surrounding the component can be understood to mean a region surrounding the motor vehicle in which the protective arrangement is used, i.e., a region outside of this motor vehicle, or also a region outside the component but still inside the motor vehicle. The protective arrangement can also have a collecting container into which the liquid can be drained. In the present case, discharging the liquid into the environment is also conceivable or legitimate, especially since such discharging into the environment is only considered in order to prevent more serious reactions in the high-voltage battery in very rare cases.

The protective arrangement is described below only with reference to a component and its drainage device. However, these configurations can also be implemented analogously for any other component, in particular several components at the same time.

One component that is most vulnerable due to the power density is, for example, a pulse inverter for driving the motor vehicle, which converts the direct voltage provided by the high-voltage battery into a three-phase alternating current for operating the drive electric motor. The reason is that the pulse inverter has an internal cooling channel, which in extreme cases can be damaged by a short circuit in the component, i.e., in the pulse inverter. The motor vehicle can also include several pulse inverters, such as one for a front axle drive and one for a rear axle drive. Other critical components that can represent the component are, for example, a battery junction box, i.e. an electronics box often arranged on the battery housing with connections for the high-voltage consumers, a battery management system control unit, a DC/DC converter, a charger, the charging socket, in which the connection for coupling with an external charging cable is provided, or basically all components that have internal cooling or an interface to the environment of the motor vehicle, such as the charging socket, and are connected, in operation, in particular through a wired connection, with the high-voltage battery.

Therefore, according to a further advantageous embodiment of the invention, it is provided that the component represents a pulse inverter. A pulse inverter typically includes power electronics, for example in the form of MOSFETs (metal oxide semiconductor field effect transistors) or IGBTs (field effect transistors with insulated gate electrode), which provide extremely high currents for the drive machine, which can be operated, for example, with a power in the range of 200 kilowatts. Accordingly, these power semiconductors must be intensely cooled. If overheating occurs for any reason, these power semiconductors can burn out, which can affect the tightness of the internal cooling channel due to the high currents, so that cooling water can get directly into the pulse inverter. Without any countermeasure, such a pulse inverter can fill up very quickly, since it typically only has a small cavity volume, so that the cable connection to the high-voltage battery is quickly reached, via which the water could then get into the high-voltage battery. A slope from the pulse inverter to the high-voltage battery is not even necessary for this, because the water pressure, which results from the pressure in the cooling circuit to which the pulse inverter's cooling system is connected, allows the water to be pumped into the battery without countermeasures. By providing a drainage device, namely the drainage device described, in or on the pulse inverter component, early drainage of such cooling water that undesirably enters the pulse inverter can be provided, so that, on the one hand, the cable connection of the cable leading to the high-voltage battery can not be reached and in addition, the coolant pressure in the pulse inverter can also be limited, since the draining liquid cannot build up a high fluid pressure within the pulse inverter. As already described above, other components are also suitable for providing a corresponding drainage device in order to protect the high-voltage battery.

In principle, the drainage device can also only be provided in the form of a drain opening with a closure. The drain opening can, for example, simply be designed as a hole in the component housing. Optionally, the drain opening can also include other structures or components, for example a pipe or a hose adjoining the component housing in the region of the drain opening in order to guide the liquid to be drained to a specific destination. The circuit component of the cooling circuit, which is arranged on the component housing, can be, for example, a cooling device for the electrical component. But it could also just be a coolant line or something similar. At the least the circuit component represents a component through which the coolant can flow. As explained in more detail later, the cooling circuit can also be divided into several partial circuits. Each of the several partial circuits can also have their own pump assigned to them. The partial circuits can, for example, be fluidly connected to one another or separated from one another by one or more valve devices. The first pump is therefore at least designed to pump the coolant through a part of the cooling circuit in which the circuit component is located. The cooling circuit and its optional sub-circuits are usually a closed circuit, i.e., normally, without defects or leaks. In other words, during operation of the at least one first pump, the coolant is circulated at least in a partial circuit of the cooling circuit or in the entire cooling circuit. The coolant is preferably a cooling liquid, for example water with optional additives.

The detection device, which is designed to detect at least a probable penetration of liquid, is preferably not designed to detect the liquid itself that has penetrated into the component housing, but rather to infer from other measured variables or signals from other components that liquid has probably penetrated into the component housing. This has the advantage that existing devices can be used to detect the penetration of liquid into the component housing, without having to provide additional liquid sensors or the like. If, due to the detection of presumed penetration of liquid, the control device controls the first pump accordingly in order to increase its pumping power if it is not already in a state of maximum pumping power, then the first pump is preferably controlled by means of the control device in such a way that the first pump is operated in the state of maximum pumping power after increasing its pumping power. This allows the closure to be opened most efficiently.

In a further advantageous embodiment of the invention the closure is designed as at least one of the following elements or components: a plug, a pressure compensation element, a bursting membrane, a rupture disk, or a valve.

All these elements are advantageously suitable for achieving a passive and pressure-dependent opening or releasing of the drain opening. A plug is, for example, an element which can be inserted into the drain opening and which is retained in the drain opening only due to friction, for example. The pressure compensation element can also ensure pressure compensation with the environment during normal operation. A bursting membrane or rupture disk is an element that is destroyed or that tears or breaks through or generally bursts due to excessive, predeterminable overpressure, thereby releasing the drain opening. The valve can be, for example, a pressure-dependent valve which opens starting from a predetermined overpressure and thereby releases the drain opening.

All these elements can advantageously be designed in such a simple way that they open from a predeterminable pressure threshold or overpressure threshold. This overpressure threshold value can be, for example, at least 0.01 bar, in particular at least and/or at most 0.05 bar, or at least and/or at most 0.2 bar, or at least and/or at most 0.5 bar overpressure. The overpressure refers to the pressure difference between the pressure inside the component housing and outside the component housing, in particular to the pressure difference between the atmospheric or fluid pressures adjacent to the closure of the drain opening on both sides.

In a further advantageous embodiment of the invention, the component housing has a connection region via which the cable for electrically connecting the component to the high-voltage battery can be connected, for example via a suitable plug, wherein a lower edge of the drain opening is arranged below the connection region relative to an intended installation position of the protective arrangement. Preferably, the drain opening is not only arranged with its lower edge below the connection region, but preferably completely. In particular, it is also advantageous from a pressure perspective if the lower edge of the drainage device or the drain opening lies below the HV (high-voltage) lines or the cables via which the component is connected to the high-voltage battery. This can ensure that the overpressure inside the component housing, which is generated in particular by the liquid that has penetrated, causes the drain opening to open before liquid can penetrate into the HV lines. It is also preferred that the drainage device is arranged in the vicinity of the connection region, for example on the same side of the component housing or integrated into a same side of the component housing. This has the advantage that it can be guaranteed that the drainage device is located below the connection region, even if the vehicle is parked on a slope, for example. In other words, the position and orientation of the vehicle in space no longer plays such an important role.

In a further advantageous embodiment of the invention, the at least one detection criterion comprises a first detection criterion, which includes that a defect in the component is detected and/or an insulation fault is detected. The defect in the component can be detected, for example, by detecting a cluster of errors or error messages for this component and/or by a total failure of this component. If liquid gets into the interior of the component housing, for example due to a leak in the cooling system, especially in the circuit component, this typically also leads to a defect in the component itself. If a component defect is detected, this can be interpreted as an indication that liquid may have penetrated the component. The same applies to the detection of an insulation fault. Since the component, for example the pulse inverter, is an electrical component, current-carrying components of this component typically come into contact with the liquid when such a liquid penetrates into the component. This reduces the insulation resistance between such current-carrying components and a defined ground. In a motor vehicle, this is typically monitored by the so-called insulation monitor. For example, if this insulation monitor reports an error, i.e., an insulation fault, this can also be seen as an indication that liquid may have penetrated the component. An exemplary embodiment of such a liquid detection by using insulation monitoring is also described, for example, in DE 10 2018 222 454 A1 and is therefore sufficiently known to a person skilled in the art, so that it will not be discussed in detail here.

Since this typically does not allow clear conclusions to be drawn about the penetration of liquid into the component, it is advantageous to provide at least one further detection criterion in addition to or in addition to this first detection criterion. This can also be provided as an alternative to the first detection criterion.

In a further advantageous embodiment of the invention the at least one detection criterion comprises a second detection criterion, which includes that a coolant level sensor detects that the coolant level falls below a fill level threshold value.

A coolant level sensor, which can also be referred to as an expansion tank coolant sensor, is typically installed in the cooling circuit of a motor vehicle. This typically measures the coolant level in the expansion tank of the coolant circuit. For example, if the coolant level is too low, corresponding information can be issued to a user or driver of the motor vehicle in order to refill coolant. For example, if there is a leak due to a defect that causes liquid to penetrate into the component, coolant will inevitably escape from the coolant circuit. This also reduces the coolant level in the expansion tank. This can be detected by the coolant level sensor. This second detection criterion can therefore also be used advantageously to detect the penetration of liquid into the component, at least indirectly. It is particularly advantageous if the at least one detection criterion detects both one of the above-mentioned first detection criteria and the second detection criterion. If a defect occurs in the affected component and the coolant level sensor shortly afterwards signals that the level has fallen below the predetermined threshold value, it is very likely that there is a leak in the cooling system and that this also leads or has led to fluid penetrating into the defective component.

According to a further very advantageous embodiment of the invention, the at least one detection criterion comprises a third detection criterion, which includes that a time interval between the fulfillment of the first detection criterion and the second detection criterion is smaller than a specific time threshold value. For example, if the leak is a very large leak, this typically results in the coolant level sensor signaling that the level has fallen below a fill level threshold value within a very short time. If a defect in the component occurs as a result of liquid penetrating into the component housing, this defect typically occurs together with the signaling of the coolant level sensor within a very short period of time. This allows conclusions to be drawn that liquid has penetrated the component. The first pump can then be activated or the pump performance can be increased or maximized. This opens the opening and allows the coolant to flow out of the component. However, if there is only a very small leak, the coolant level sensor will not immediately signal that the level has fallen below a threshold value; this will then take correspondingly longer. In the case of a small leak, however, activating the first pump in order to increase or maximize the pump performance in order to open the drain opening does not have a particularly great effect, as also due the increased coolant pressure in the cooling circuit due to the very small leak opening in the component housing the increased coolant pressure in the cooling circuit cannot be transferred to the coolant in the component housing. In other words, no better or faster opening of the drain opening can be achieved in this way. In this case, a corresponding pump control can also be dispensed with. Rather, other measures are available in this case. Accordingly, it is very advantageous to consider the period between the detection of a defect or the detection of an insulation fault on the one hand and the signaling of the coolant level sensor on the other hand. Based on the consideration of the period between the fulfillment of the first and second detection criteria, the size of the leak can therefore also be deduced. If this period is very long or greater than the specific time threshold, for example, a warning can be issued to the driver or a request can be issued to visit a workshop as soon as possible.

As described, the control device only controls the first pump accordingly if at least one or preferably more of the above detection criteria are met. Otherwise, the first pump can be controlled according to its normal pump control.

In a further advantageous embodiment of the invention, the control device is designed to control the first pump in such a way that the increased pump power is provided for a maximum of a predetermined period, in particular which is at least several seconds and is less than 5 minutes, in particular up to a maximum of 1 minute. This is particularly advantageous since it typically does not take long, for example with a sufficiently large leak, until the drain opening can be opened by increasing the pumping power or maximizing the pumping power. By temporarily activating the first pump or by limiting the time the first pump operates at the increased or maximized performance level, excessive coolant loss can be avoided. This has the great advantage that the remaining coolant remaining in the cooling circuit can be used for other purposes, for example to additionally actively cool the high-voltage battery in order to avoid possible damage or thermal runaway of the high-voltage battery if liquid, for whatever reason, has nonetheless penetrated into the high-voltage battery.

Therefore, in a further very advantageous embodiment of the invention the cooling circuit has a first circuit part and a second circuit part, wherein the circuit component and the first pump are part of the first circuit part, wherein the second circuit part comprises a cooling device for cooling the high-voltage battery and a second pump, which is designed to pump coolant through the cooling device, wherein the control device is designed to control the first pump and the second pump after the predetermined period of time has elapsed in such a way that the second pump is operated with a higher pump power than that first pump, and which is designed in particular to deactivate the first pump. By deactivating the first pump, as described, coolant can be prevented from being actively and unnecessarily pumped out of the cooling circuit due to the leak. The coolant remaining in the cooling circuit can advantageously be used to be circulated in the second circuit part by means of the second pump, in order to still cool the high-voltage battery via the cooling device. It is also advantageous if, when driving the first and second pumps after the predetermined period has elapsed, the first circuit part is also fluidically decoupled from the second circuit part. For example, a valve can be provided between the two circuit parts, which is closed. This can prevent coolant from continuing to escape from the cooling circuit. By additionally cooling the high-voltage battery, thermal runaway can be prevented as a precautionary measure.

Furthermore, the invention also relates to a motor vehicle having a protective arrangement according to the invention or one of its embodiments. The advantages mentioned for the protective arrangement according to the invention and its embodiments thus apply equally to the motor vehicle according to the invention. Furthermore, the motor vehicle can comprise all components mentioned in the description of the protective arrangement, for example also the high-voltage battery.

The motor vehicle according to the invention is preferably designed as an automobile, in particular as a passenger car or truck, or as a passenger bus or motorcycle.

The invention also relates to a method for operating a protective arrangement for a motor vehicle for protecting a high-voltage battery of the motor vehicle from the penetration of liquid, wherein the protective arrangement has an electrical component which is connected to the high-voltage battery via a cable and which comprises a component housing and a drainage device connected to the component housing with a drain opening in the component housing, via which, if liquid penetrates into the component housing, the liquid can be drained from the component housing into an region surrounding the component outside the high-voltage battery, wherein the drainage device has a closure which closes the drain opening and by means of which the drain opening can be released depending on the pressure. In this case, a detection device detects an at least probable penetration of liquid from the circuit component of a cooling circuit into the component housing in accordance with at least one predetermined detection criterion and a control device controls a first pump of the cooling circuit for pumping the coolant depending on the detection of the at least probable penetration of the liquid by the detection device through the circuit component in such a way that an increased pumping power is at least temporarily provided by the first pump if the first pump is not yet in a state of maximum pumping power.

The invention also includes developments of the method according to the invention, which comprise features which have already been described in conjunction with the developments of the protective arrangement according to the invention. For this reason, the corresponding developments of the method according to the invention are not described again here.

The control device for the protective arrangement also belongs to the invention. The control device can have a data processing device or a processor device which is set up to perform an embodiment of the method according to the invention. For this purpose, the processor device can have at least one microprocessor and/or at least one microcontroller and/or at least one FPGA (Field Programmable Gate Array) and/or at least one DSP (Digital Signal Processor). The processor device can also comprise program code, which is designed, upon execution by the processor device, to perform the embodiment of the method according to the invention. The program code can be stored in a data storage of the processor device. A processor circuit of the processor device can have, for example, at least one circuit board and/or at least one SoC (System on Chip).

The invention also comprises the combinations of the features of the described embodiments. The invention therefore also comprises implementations that each have a combination of the features of several of the described embodiments, provided that the embodiments have not been described as mutually exclusive.

### BRIEF DESCRIPTION OF THE FIGURES

Exemplary embodiments of the invention are described hereinafter. In particular:

FIG. 1 shows a schematic representation of a pulse inverter in a high-voltage battery in the event of a coolant leak according to an example not belonging to the invention;

FIG. 2 shows a schematic representation of a motor vehicle having a protective arrangement according to an exemplary embodiment of the invention; and

FIG. 3 shows a schematic representation of a motor vehicle having a protective arrangement of FIG. 2 in the opened state of the drainage device according to an exemplary embodiment of the invention.

### DETAILED DESCRIPTION

The exemplary embodiments explained hereinafter are preferred embodiments of the invention. In the exemplary embodiments, the described components of the embodiments each represent individual features of the invention to be considered independently of one another, which each also develop the invention independently of one another. Therefore, the disclosure is also intended to comprise combinations of the features of the embodiments other than those represented. Furthermore, the described embodiments can also be supplemented by further ones of the above-described features of the invention.

In the figures, same reference numerals respectively designate elements that have the same function.

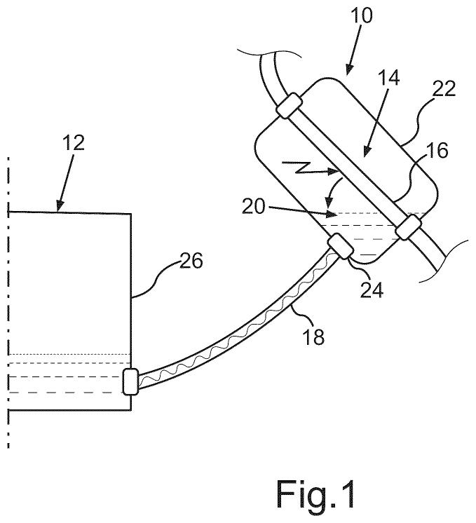

FIG. 1 shows a schematic representation of a pulse inverter 10 and a high-voltage battery 12 in the event of a leak 14 in the coolant line passing through the pulse inverter 10 in the form of a cooling channel 16 according to an example not part of the invention. The pulse inverter 10 is connected to the high-voltage battery 12 via a cable 18. If there is a leak in the cooling channel 16, which runs through the pulse inverter 10, coolant 20 gets into the housing 22 of the pulse inverter 10, which quickly fills up as a result. The connection region 24 of the cable 18 to the high-voltage battery 12 can also be reached by the liquid level, so that the coolant could now also reach the interior 26 of the high-voltage battery 12. Even if the cable guide 18, as shown here, had no slope, it is in principle possible for the coolant 20 collecting in the pulse inverter 10 to be pumped into the battery 12 at a pressure due to the coolant pressure in the cooling circuit. In other words, in the event of a fault, the coolant 20 is pressed into the pulse inverter 10 due to the pump pressure of the cooling circuit and also due to the pressure created by the temperature in the cooling system. This pressure may be sufficient under certain circumstances to direct the coolant 20 via the high-voltage lines 18, possibly via further high-voltage components, into the high-voltage battery 12.

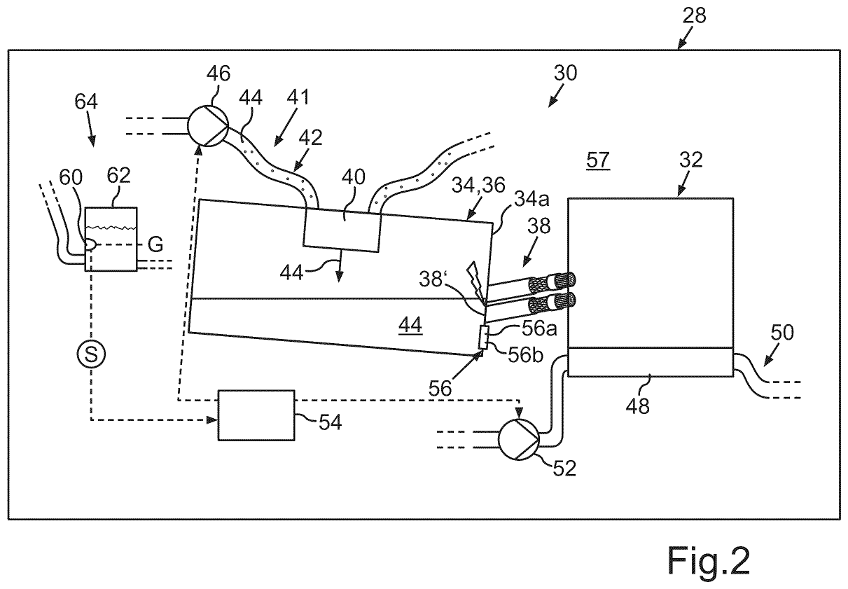

FIG. 2 shows a schematic illustration of a motor vehicle 28 having a protective arrangement 30 according to an exemplary embodiment of the invention. The parts of the motor vehicle 28 described below can also be part of the protective arrangement 30 or can be viewed as belonging to the protective arrangement 30. First of all, the motor vehicle 28 has a high-voltage battery 32. The motor vehicle also has a component 34, in particular an electrical component 34, which in this example is designed as a pulse inverter 36. In general, however, this component 34 can be any in particular high-voltage component, which is electrically connected to the high-voltage battery 32 via a cable 38, in particular in the present example via two high-voltage cables 38. Cables 38 are connected in a connector region 38′ to the component housing 34a of the pulse inverter 36. In this example, the pulse inverter 36 can again be cooled by means of a cooling device 40 as an example of a circuit component 40 of a cooling circuit 41 with a first circuit part 42. A first pump 46 is assigned to this first cooling circuit part 42. By means of the first pump 46, coolant 44 can therefore be pumped through the first cooling circuit part 42 and thus also through the circuit component 40. The coolant 44 is pumped or circulated through the first cooling circuit part 42 by means of a pump 46 assigned to the first cooling circuit part 42 and thus cools the pulse inverter 36 via the cooling device 40 during normal operation. The cooling device 40 can be integrated into the pulse inverter 36 or at least rest on its housing 34a or be arranged on it. The cooling device 40 can comprise one or more cooling channels for guiding the coolant 44, which channels can also be integrated into the pulse inverter 36.

A second cooling device 48 can be provided for the high-voltage battery 32, which device can cool the high-voltage battery 32 if necessary. In this example, this cooling device 48 is part of a second cooling circuit part 50. This is also assigned a second coolant pump 52 in order to pump or circulate the coolant 44 through this second cooling circuit part 50. The two cooling circuit parts 42, 50 can also be coupled and connected to form the common cooling circuit 41 or operated separately from one another. The fluidic coupling and separation can be accomplished, for example, by at least one valve device, not shown in detail here. In general, corresponding valve devices can therefore be provided. These could, for example, be designed to be controllable by means of the control device 54, which will be explained in more detail below.

The component 34, in the present example the pulse inverter, is now advantageously designed with a drainage device 56 which is arranged on the housing 34a. The drainage device 56 has an opening 56a and a closure 56b, which closes the opening 56a in the normal state. In the open state, the opening 56a establishes a fluid connection between the interior of the housing 34a and the environment 57. If the closure 56b is opened and the opening 56a is thereby released, then in the event of a leak, liquid 44 or water, in particular the cooling liquid 44, collecting in the pulse inverter 36 can be drained from the component housing 34a. The closure 56b is designed, for example, as a plug or rupture disk or similar. The closure 56b can also be designed as a pressure compensation element, in particular with a defined seat. Such a pressure compensation element can also be referred to as a pressure compensation plug. Furthermore, such a pressure compensation element, which can be provided, for example, in the component 40 anyway for the purpose of pressure compensation with the environment 57, can be modified so that it pops out or opens the outlet opening 56a starting from a certain internal pressure or overpressure relative to the environment 57. In any case, the closure 56b is a passively releasable pressure-dependent closure 56b, which opens the opening 56a, for example by being pushed out or bursting, when a certain overpressure limit value is exceeded.

It is now particularly advantageous if the control device 54, in the event that a probable penetration of liquid 44 into the pulse inverter 36 is detected, controls at least the first pump 46 in such a way that the pump power is increased or maximized, at least if the pump 46 is not already operating at its maximum performance level. As a result, the pushing out or opening of the closure 56b can be forced. The detection of the probable penetration of the liquid 44 into the pulse inverter 36 can be accomplished in a variety of ways. For example, a defect in the pulse inverter 36 can be detected. A defect can be detected, for example, by detecting an insulation resistance fault and/or detecting a failure of the pulse inverter 36 or by detecting accumulating errors in the pulse inverter 36. A further indication of the penetration of liquid can be provided via a fill level sensor 60 of an expansion tank 62 for the coolant 44. This fill level sensor 60 detects when the fill level in the expansion tank 62 falls below a certain limit value G.

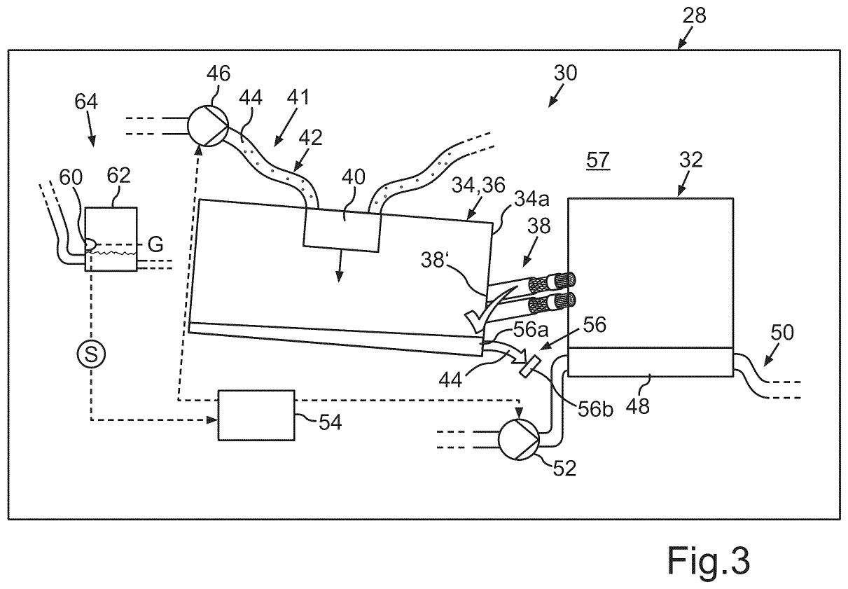

If this is the case, as shown for example in FIG. 3, then this fill level sensor 60 can deliver a signal S to the control device 54. The fill level sensor 60 can, for example, be considered part of the detection device 64 for detecting the probable penetration of the liquid 44 into the pulse inverter 36. Further criteria for the detection can be that the fall below the limit value G in the expansion tank 62 is reported to the control device 54 by the fill level sensor 60 within a predetermined period, measured from the point in time from which a defect in the component 34 was also detected. This suggests that the leakage is sufficiently large to be able to cause the opening 56a to open by activating the pump 46. If the liquid 44 is eventually detected by one or more of these criteria with a certain probability, the control device 54 controls the pump 46 in order to release the opening 56a by releasing the closure 56b.

The released closure is shown in FIG. 3. In particular, FIG. 3 shows a schematic representation of the motor vehicle 28 with the protective arrangement 30 of FIG. 2 in a state in which the closure 56b is opened and thus the opening 56a is now released. As a result, the liquid 44 that has collected in the component 34 can advantageously escape or flow out of the component housing 34a. This can prevent the liquid 44 from getting into the high-voltage battery 32. It is also advantageous if the control device 54 controls the pump 46 again after a predetermined time in order to preferably deactivate the pump 46 and instead activate the second pump 52 in order to additionally temporarily cool the high-voltage battery 32 by means of the cooling device 48. to counteract a possible thermal event. For this purpose, the residual coolant 44 remaining in the cooling circuit 41 can then advantageously be used.

Overall, the examples show how the invention can be used to avoid longitudinal water transfer into the high-voltage battery.

1. A protective arrangement for a motor vehicle for protecting a high-voltage battery of the motor vehicle from the penetration of liquid, the protective arrangement comprises:
an electrical component which can be connected to the high-voltage battery via a cable, which comprises a component housing and a drainage device connected to the component housing with a drain opening in the component housing, via which opening, in the event of liquid penetrating into the component housing, the liquid can be drained from the component housing into a surrounding region of the component outside the high-voltage battery, wherein the drainage device has a closure which closes the drain opening and by which the drain opening can be released depending on the pressure,
a cooling circuit with a circuit component through which a coolant can flow, and having a pump for pumping coolant through the circuit component, wherein the circuit component is arranged on the component housing,
a detection device which is designed to detect at least presumed penetration of liquid from the circuit component into the component housing according to at least one predetermined detection criterion; and
a control device which is designed to control the pump as a function of detection by the detection device of the at least presumed penetration of the liquid in such a way that increased pumping capacity is at least temporarily provided, if the pump is not yet in a state of maximum pumping capacity.

2. The protective arrangement according to claim 1, wherein the closure is designed as at least one of the following elements:
a plug,
a pressure compensation element
a bursting membrane,
a rupture disk,
a valve.

3. The protective arrangement according claim 1, wherein the component housing has a connection region via which the cable can be connected for electrically connecting the component to the high-voltage battery, wherein a lower edge of the drain opening is arranged below the connection region relative to an intended installation position of the protective arrangement.

4. The protective arrangement according to claim 1, wherein the at least one detection criterion involves a first detection criterion which includes,
the detection of a defect in the component; and/or
the detection of an insulation fault.

5. The protective arrangement according to claim 1, wherein the at least one detection criterion involves a second detection criterion including a coolant level sensor detecting when the coolant level falls below a fill level threshold.

6. The protective arrangement according to claim 1, wherein the at least one detection criterion involves a third detection criterion, wherein a time interval between the fulfillment of the first detection criterion and the second detection criterion is below a specific time threshold.

7. The protective arrangement according to claim 1, further comprising: a control device is designed to control the pump in such a way that it provides the increased pumping capacity for a maximum of a predetermined period, in particular which is at least several seconds and is less than 5 minutes, in particular up to a maximum of 1 minute.

8. The protective arrangement according to claim 1, wherein the cooling circuit has a first circuit part and a second circuit part, wherein the circuit component and the pump are part of the first circuit part, and wherein the second circuit part comprises a cooling device for cooling the high-voltage battery and a second pump which is designed to pump coolant through the cooling device, wherein the control device is designed, after the predetermined period of time has elapsed, to control the first pump and the second pump in such a way that the second pump is operated with a higher pumping capacity than the first pump, in particular to deactivate the first pump.

9. A motor vehicle having a protective arrangement according to claim 1.

10. A method for operating a protective arrangement for a motor vehicle for protecting a high-voltage battery of the motor vehicle from the penetration of liquid, comprising:
the protective arrangement has an electrical component which is connected to the high-voltage battery via a cable, which component comprises a component housing and a drainage device connected to the component housing with a drain opening in the component housing, via which opening, in the event of liquid penetrating into the component housing, the liquid can be drained from the component housing into a surrounding region of the component outside the high-voltage battery, wherein the drainage device has a closure which closes the drain opening and by which the drain opening can be released depending on the pressure,
wherein a detection device detects at least presumed penetration of coolant from the circuit component of a cooling circuit into the component housing according to at least one predetermined detection criterion; and
wherein a control device, depending on detection of the at least probable penetration of the liquid by the detection device, controls a pump of the cooling circuit for pumping the liquid through the circuit component in such a way that the pump at least temporarily provides increased pumping power if the pump is not yet in a state of maximum pumping power.

11. The protective arrangement according claim 2, wherein the component housing has a connection region via which the cable can be connected for electrically connecting the component to the high-voltage battery, wherein a lower edge of the drain opening is arranged below the connection region relative to an intended installation position of the protective arrangement.

12. The protective arrangement according to claim 2, wherein the at least one detection criterion involves a first detection criterion which includes,
the detection of a defect in the component; and/or
the detection of an insulation fault.

13. The protective arrangement according to claim 3, wherein the at least one detection criterion involves a first detection criterion which includes,
the detection of a defect in the component; and/or
the detection of an insulation fault.

14. The protective arrangement according to claim 2, wherein the at least one detection criterion involves a second detection criterion including a coolant level sensor detecting when the coolant level falls below a fill level threshold.

15. The protective arrangement according to claim 3, wherein the at least one detection criterion involves a second detection criterion including a coolant level sensor detecting when the coolant level falls below a fill level threshold.

16. The protective arrangement according to claim 4, wherein the at least one detection criterion involves a second detection criterion including a coolant level sensor detecting when the coolant level falls below a fill level threshold.

17. The protective arrangement according to claim 2, wherein the at least one detection criterion involves a third detection criterion, wherein a time interval between the fulfillment of the first detection criterion and the second detection criterion is below a specific time threshold.

18. The protective arrangement according to claim 3, wherein the at least one detection criterion involves a third detection criterion, wherein a time interval between the fulfillment of the first detection criterion and the second detection criterion is below a specific time threshold.

19. The protective arrangement according to claim 4, wherein the at least one detection criterion involves a third detection criterion, wherein a time interval between the fulfillment of the first detection criterion and the second detection criterion is below a specific time threshold.

20. The protective arrangement according to claim 5, wherein the at least one detection criterion involves a third detection criterion, wherein a time interval between the fulfillment of the first detection criterion and the second detection criterion is below a specific time threshold.
